(19) United States
(12) Patent Application Publication
(10) Pub. No.: US 2021/0352880 A1
(43) Pub. Date: Nov. 18, 2021

(54) FISH BAIT DEVICE AND RELATED METHODS

(71) Applicant: Miguel Zertuche, Templeton, CA (US)

(72) Inventor: Miguel Zertuche, Templeton, CA (US)

(21) Appl. No.: 17/213,229

(22) Filed: Mar. 26, 2021

Related U.S. Application Data
(60) Provisional application No. 63/024,509, filed on May 13, 2020.

(51) Int. Cl. A01K 85/18; A01K 83/06

(52) U.S. Cl. CPC A01K 85/18; A01K 83/06

(57) ABSTRACT

The present invention provides a bait device and method for making such bait device that includes forming sea urchin meat into a pellet structure operable to release meat at a measured rate. The bait device may comprise a casing (e.g. a membrane or fine mesh), that envelopes all or some of a pellet. Further disclosed is a fishing devices that may include a body in which the bait device may be inserted. When submerged, the bait device may be operable to release small particles of the sea urchin meat into the water in a controlled manner, attracting fish without the pellet falling apart or being easily eaten off of the lure or hook without catching the fish.

### FIELD OF THE INVENTION

The present invention relates to fishing bait, and more specifically to novel bait pellets made from sea urchin and other invertebrate tissue for use with fishing lures and hooks.

### DISCUSSION OF THE BACKGROUND

Use of sea urchin as fish bait is becoming more well-known and popular for certain types of saltwater fishing. In particular, fishermen angling for California sheephead, Hawaiian uhu, and many other species of saltwater fish prefer to utilize sea urchin as bait in order to increase the size and quantity of their catch.

Current methods of using sea urchin as fish bait include cutting or prying off the outer spines of an urchin, followed by jamming a large hook through the urchin, or cutting the urchin in half and putting the hook through the half-shell. These techniques better attract fish by exposing the internal organs of the urchin, primarily consisting of the gonads. However, simply putting a hook through the urchin fails to effectively expose the gonads of the urchin to attract fish, and cutting the urchin in half may allow the gonads to tear away from the shell or be eaten by a fish without the fish being hooked. Further, a single urchin contains several (typically five) gonads, each of which could potentially attract its own fish or multiple fish if properly separated from the shell. Unfortunately, however, the gonads are very delicate and are likely to tear away from a lure if simply impaled on a hook.

Also, collecting sea urchin for use as bait is a time-consuming, expensive, and sometimes dangerous process. Sea urchin collectors must either scour coastal rocks and wharf posts at low tide on foot, or use diving equipment in deeper water or at high tide, prying each individual sea urchin off its perch by hand. Adding to these difficulties is the mounting popularity of culinary options, such as sushi and pasta, in which sea urchin gonads (known by its Japanese name, “uni”) are considered a delicacy. Sea urchin is thus becoming both scarcer for collection as bait due to commercial fishing, and more expensive to purchase as bait due to higher demand in restaurants.

Therefore, what is needed is a method of using sea urchin as fish bait which is more conserving of this limited resource, allowing for the gonads of a single sea urchin to be separated from the shell and used to bait multiple lures without falling apart and falling away from the lure.

### DESCRIPTION OF THE INVENTION

The present invention provides a bait device and method for using sea urchin meat mixed with Haliotis rufescens (purpled hinged rock scallop guts) and Crassadoma gigantea (Red abalone trim/guts) with (e.g., tissues and organs of the sea urchin such as the gonads) and converted into a bait pellet for use in specialized bait fish or other device for catching fish. The bait device may comprise the sea urchin meat wrapped in a casing (e.g., a membrane or fine mesh) and formed into a pellet which may be inserted into a cavity in the body of a lure. When submerged, the bait device may be operable to release small particles (e.g., in a range of about 0.01 mm to about 2.0 mm) of the urchin meat into the water, attracting fish without the urchin meat falling apart or being easily eaten off of the lure or hook without also hooking the fish.

The bait device and method may also utilize a volume of sea urchin meat which is less than the volume of one gonad of the sea urchin, allowing the meat of a single sea urchin to be utilized on several different lures and/or hooks. The present invention may thus allow a fisherman to use scarce and expensive sea urchin meat more efficiently and effectively, reducing the number of sea urchins necessary for fishing, and saving time and money. The utilization of the purple sea urchin refuse produced by organized removal events is an important aspect of the pellet harvesting process

The bait device and method may also utilize multiple different species of sea urchin (e.g., Mesocentrotus franciscanus, commonly known as red sea urchin, and Strongylocentrotus purpuratus, commonly known as purple sea urchin, among others) and multiple different types, shapes, and sizes of lures, cages, nets, and other implements for catching fish. Thus, many different fishing styles targeting many different species of fish may be accommodated by the present invention without the need to buy expensive new equipment or find new sources of sea urchin meat.

Also, the bait device and method may utilize casings made from a material having an acceptable porosity or permeability that in conjunction with a retaining device (e.g., rubber band) and release small particulates of sea urchin meat into the water to attract fish to the bait. The porosity of the casing may be varied somewhat to accommodate different styles of fishing (e.g., trolling for large fish may require a casing with a greater porosity, while a casing may be appropriate for fishing with a lower porosity a lure dropped from an anchored boat), but it is important to prevent rapid loss of the sea urchin material from the bait pellet. The sea urchin meat loses its structural integrity after being processed for use as bait, and the sea urchin material becomes a fine particulate material with little adherence. Thus, the porosity of the casing must be fine in order to retain the sea urchin material.

The present invention may provide a bait device for efficiently and effectively using sea urchin meat as fish bait. The bait device may comprise sea urchin meat, processed and wrapped in a casing and formed into a pellet, and a fishing device for securing the pellet and catching a fish.

The sea urchin meat may comprise any tissue of any species of sea urchin. In some embodiments, the sea urchin meat may comprise at least one of a gonad (e.g., the sex organ of the sea urchin, typically a delicate yellow or orange organ having a tongue shape with a rough appearing surface) and gametes (e.g., eggs or sperm produced by the gonad of the sea urchin, the eggs commonly known as roe). In other embodiments, the sea urchin meat may comprise at least one of the other organs or tissues of a sea urchin (e.g., muscles, mouth and jaw, digestive tract, vascular system, axial gland, ampullae, and/or tube feet). In some embodiments, the sea urchin meat may comprise a mixture of all internal organs and/or tissues of the sea urchin. In some embodiments, the sea urchin meat may comprise the tissues of a single sea urchin. In other embodiments, the sea urchin meat may comprise the tissues of a plurality of sea urchins.

The sea urchin meat may comprise the tissue of any species of sea urchin. In some embodiments, the sea urchin meat may comprise the tissue of a red sea urchin (Mesocentrotus franciscanus). In other embodiments, the sea urchin meat may comprise the tissue of a purple sea urchin (Strongylocentrotus purpuratus). In yet other embodiments, the sea urchin meat may comprise the tissues of both a red sea urchin and a purple sea urchin. In some embodiments, the sea urchin meat may comprise the tissue of Haliotis rufescens (purpled hinged rock scallop guts) and Crassadoma gigantea (Red abalone trim/guts).

The sea urchin meat may be processed into a pellet, wherein the sea urchin meat is mashed, ground, or blended into a paste, wrapped in a casing (e.g., encapsulated in the casing), and formed into a pellet shape (e.g., a cylindrical shape, a spherical shape, a hemispherical shape, a cubic shape, or other similar shape beneficial for engagement with a fishing device). In other embodiments, the sea urchin meat may be formed into a pellet via a mold. In some embodiments, the mold may comprise a tray having a plurality of cavities, each cavity comprising a pellet shape (e.g., a plurality of cylindrical shaped cavities). In other embodiments, the tray may comprise a plurality of differently shaped cavities for providing pellets of multiple shapes (e.g., a cylindrical shape, substantially spherical or hemispherical shape, a cubic shape, etc.) and sizes (e.g., a cylinder having a diameter and a length, each in a range of about 2 mm to about 20 mm, and preferably in a range of about 5 mm to about 10 mm) corresponding to the shapes and sizes of cavities in the lure(s) in which the pellets are to be inserted. The cavities may pass through the entire body of the lure or may dead end in the lure. In still other embodiments, the cavities may be connected with channels (e.g., smaller diameter channels) that have a non-rectilinear path through the lure, and may branch to create one more channel outlets at the surface of the lure. The lures may be of various sizes (e.g., 6 oz., 8 oz., 10 oz., 12 oz., etc.)

In some embodiments, the pellets may be frozen after being formed into the pellet shape. Freezing the pellets may both provide preservation of the sea urchin meat prior to being inserted into or onto the fishing device (e.g., to prevent to the sea urchin meat from rotting in the time between processing the meat and using it as fish bait), and provide rigidity and stability to the fragile sea urchin meat allowing the pellet to be inserted into or onto the fishing device and immersed into water without disintegrating.

In some embodiments, the sea urchin meat may be mixed with a preserving agent to prevent rotting of the sea urchin meat and/or a binding agent to stiffen or strengthen the pellet. The preserving agent of the present invention may comprise a naturally occurring preserving agent (e.g., salt, essential oils, and similar agents) or any commercially available preserving agent (e.g., sodium tripolyphosphate, and similar agents) sufficient to slow the rotting or spoiling of seafood. The binding agent of the present invention may comprise a naturally occurring binding agent (e.g., eggs, starches, lactose powder, sucrose powder, tapioca flour, emulsifiers, guar, gum Arabic, tragacanth, xanthan, and similar agents) and/or one or more manufactured binding agents (e.g., microbial transglutaminase (MTG) and/or sodium caseinate, cellulose, microcrystalline cellulose, polyphosphate, polyvinylpyrrolidone, and similar agents) sufficient to bind pieces of processed seafood together to form a pellet.

In some embodiments, the sea urchin meat may be mixed with other components which are useful for forming the pellet and/or attracting fish. In some embodiments, the pellet may comprise the tissue (e.g., meat, shell, and organs) of other sea creatures (e.g., shrimp, crab, fish, and Haliotis rufescens (purpled hinged rock scallop guts) and Crassadoma gigantea (Red abalone trim/guts)). In other embodiments, the pellet may comprise an oil derived from other sea creatures (e.g., shrimp oil, crab oil, fish oil, and Haliotis rufescens (purpled hinged rock scallop guts) and Crassadoma gigantea (Red abalone trim/guts)). In yet other embodiments, the pellet may comprise a processed or synthetic component known in the fishing art to attract fish.

The casing may comprise a material operable to incrementally release the sea urchin meat (and any other components of the pellet) from the pellet in a controlled manner (e.g., the pellet dissolves, releasing small pieces of sea urchin meat into the water slowly), such that target fish are able to sense the pellet engaged with the fishing device for a substantial amount of time (e.g., in a range from about 15 minutes to about 60 minutes). In some embodiments, the casing may comprise a material having a porosity which allows only very small pieces of the sea urchin meat (and any other components of the pellet) to release into the water, (e.g., a porosity in a range from about 0.05 mm to about 3 mm, and preferably in a range of about 0.5 mm to about 1.5 mm). In some embodiments, such porosity may be achieved with a single layer of the casing material. In other embodiments, such a porosity may be achieved by wrapping the sea urchin meat in a plurality of layers of material the same or varying porosity, the plurality of layers working in concert to create a barrier with an effective porosity as described above.

In some embodiments, the casing may comprise a fiber-based fabric (e.g., cheesecloth, Surgitube® tubular gauze, other cotton fabrics, polyester fabric, nylon fabric, and the like). In other embodiments, the casing may comprise a mesh netting (e.g., carp stocking, Atlas® net roll netting, Surginet® tubular elastic netting, and the like). In yet other embodiments, the casing may comprise a biological membrane (e.g., intestinal linings such as hog casings or fish intestine, or other membranes commonly known as caul fat, silver skin, and the like). Such biological membranes may be stretched and/or perforated in order to provide sufficient porosity. In yet other embodiments, the casing may comprise a fabricated membrane comprising a natural material (e.g., a thin layer of gelatin, resin, and the like) or a synthetic material (e.g., a thin membrane of latex, polyurethane, polyisoprene, and the like). In some embodiments, the casing may comprise a plurality of layers of different materials (e.g., cheesecloth and a layer of gelatin, or a biological membrane and nylon mesh, etc.).

The fishing device may comprise any device operable to be engaged with the pellet and catch a fish. The fishing device may comprise at least one of a lure, a cage, and the like. In some embodiments, the fishing device may comprise a lure tied to the line of a fishing pole. The lure may comprise a body and a hook, wherein the body and the hook may each have one of a broad range of shapes and sizes which are known in the fishing art to be effective at catching a fish. In some embodiments, the lure may comprise a body having, and at least one hook extending from the body. The lure may comprise at least one cavity in the body for inserting and securing at least one bait pellet as described herein, the at least one cavity having a shape complementary to a shape of the at least one pellet (e.g., a cylindrical shape, a substantially spherical or hemispherical shape, a cubic shape, and the like).

In other embodiments, the body may comprise a shape substantially similar to the shape of a full fish body, a shape substantially similar to a fish head, or a shape substantially similar to the shape of an invertebrate sea creature such as a squid. In yet other embodiments, the body may comprise a generally hydrodynamic shape such as a bullet shape or a generally cylindrical shape having ends which taper to a smaller diameter than a midpoint of the body. In some embodiments, the body may have a shape comprising a plurality of the shapes described above.

In some embodiments, the lure may comprise a single hook in static connection with the body. In other embodiments, the lure may comprise a plurality of static hooks. In yet other embodiments, the lure may comprise at least one multi-point hook connected to the body via an eyelet or loop which allows the multi-point hook to swing freely in relation to the body. In some embodiments, the lure may comprise a plurality of hooks swinging freely from the body.

The lure may comprise at least one cavity in the body for inserting and securing at least one pellet, the at least one cavity having a shape complementary to a shape of the at least one pellet (e.g., a cylindrical shape, a substantially spherical or hemispherical shape, a cubic shape, and the like). The at least one cavity may comprise a size and shape complementary to the size of the at least one pellet (e.g., about 2 mm to about 20 mm, and preferably in a range of about 5 mm to about 10 mm). In some embodiments, the body may comprise a plurality of cavities for securing a plurality of pellets. In some embodiments, the plurality of cavities may each comprise the same size and shape. In other embodiments, the plurality of cavities may comprise a first cavity having a first shape and a first size complementary to the size and shape of a first pellet, and a second cavity having a second shape and a second size complementary to the size and shape of a second pellet.

The cavity or plurality of cavities may be located in any position(s) on the body which is advantageous for attracting a fish. In some embodiments, the lure may comprise a fish head shaped body and the cavity may comprise a cylindrical shape and be located on a front surface of the body (e.g., near where the mouth of the fish head would be) and/or on a rear surface of the body (e.g., near where the hook is attached to the body). In other embodiments, the lure may comprise a bullet-shaped body and the cavity may be located at the tip of the bullet shape on a lateral side thereof. In yet other embodiments, the lure may comprise a tapered cylindrical shape, and the cavity may comprise a first cavity and a second cavity, the first cavity being located on a lateral surface (e.g., the curved outer surface of the cylinder shape) of the body near a leading end (e.g., the end tied to the fishing line) of the body, and the second cavity also being located on the lateral surface of the body near a trailing end (e.g., the end opposite the fishing line and having the eyelet for securing the hook). In further embodiments, the lure may have a tapered body with a plurality of cavities (e.g., 2, 3, 4, 5 or 6) at various positions on the body (e.g., along the lateral sides, along the tope and bottom surfaces, and/or at the proximal and distal ends thereof).

The present invention provides methods for making and using novel fish bait pellets. The method may comprise the steps of providing sea urchin meat, processing the sea urchin meat, forming the sea urchin meat into a pellet shape, wrapping the sea urchin mean in a casing, and deploying the pellet in a complementary lure device. The step of providing sea urchin meat may comprise harvesting the tissue of one or more sea urchin. The step of processing the sea urchin meat may comprise harvesting the tissue from the opened sea urchin (e.g., cutting or scraping the soft tissue away from the shell of the sea urchin) and forming the tissue into a pliable form (e.g., reducing the tissue to a mass having a substantially uniform consistency by at least one of crushing, pressing, chopping, dicing, or the like). Forming the tissue into a pliable form may comprise at least one of mechanically mashing the tissue, using a mortar and pestle, chopping and pressing with a knife or other tool, using a blender, or other similar method of forming the tissue. In some examples, and without limitation, the tissue may be processed into a mass of substantially uniform consistency. In some embodiments, the step of processing the sea urchin meat may comprise adding at least one of a preserving agent, a binding agent, and the tissue of one or more other animals to the sea urchin meat, such as fishmeal comprising various kinds of fish, crustaceans, or other sources.

The binding agent may assist in maintaining the integrity of the pellet as it is handled by a fisherman and aids in limiting the disintegration of the pellet when it is submerged in water for use as bait. The binding agent may be egg, egg whites, gelatin, starch, soy powder, lactose powder, sucrose powder, xanthan, tragacanth, gum Arabic, guar gum, agar, very finely ground flax meal, finely ground chia seed, nut butters, seed butters, and/or gluten. In other embodiments, a cold-binding agent that may include microbial transglutaminase (MTG) and/or sodium caseinate, cellulose, microcrystalline cellulose, polyphosphate, polyvinylpyrrolidone, and similar agents to provide suitable protein—water interaction and binding properties in the pellets.

The step of forming the sea urchin meat into a pellet shape may comprise depositing the processed sea urchin meat into a mold using a dispenser such as a pastry piping bag, or other appropriate mechanism. In yet other embodiments, the mass of processed sea urchin meat may be formed into a plurality of pellets by a pellet extruder or by pressing the processed meat into a tray having a plurality of pellet shaped cavities (e.g., a tray with a plurality of substantially cylindrical cavities, each cavity having an open upper end).

In some embodiments, the processed sea urchin meat may be wrapped in a casing or casings before being formed into a pellet or pellets. In other embodiments, the processed sea urchin meat may be formed into a pellet shape prior to being wrapped in a casing. In some embodiments, the processed urchin meat may be deposited directly into a casing material to be shaped into a pellet. For example, a mold may be lined with a casing material prior to the processed sea urchin meat being extruded into the mold. The mold may shape the processed sea urchin meat into a pellet with the casing material on an outer surface thereof. The processed pellets may be frozen to preserve the processed sea urchin meat. In some embodiments, the step of forming the sea urchin meat into a pellet shape may comprise freezing the pellet(s) (e.g., putting the formed pellet(s) into a freezer until the pellets are frozen) to strengthen the pellet shape and to preserve the sea urchin meat. In such embodiments, the pellet(s) may remain frozen until the step of engaging the pellet(s) with a fishing device or a plurality of fishing devices.

In some embodiments, the casing material may be applied to the pellets after the pellets have been frozen. In some embodiments, the casing material may be applied to the pellet by dipping, spraying, brushing, or other technique. The casing material may be a liquid applied to the exterior capable of congealing or drying on the outer surface of the pellet. The casing material may include a water-soluble protein-based film forming material such as gelatin, and/or a water-soluble film-forming polymer such as methylhydroxy-propylcellulose and/or sodium alginate. Multiple layers of casing material may be applied to the outer surface of the pellets. For example, a sodium alginate layer may be applied and dried, and subsequently a gelatin layer may be applied in order to improve the integrity of the pellet in water and/or during handling.

In some embodiments, the step of wrapping the sea urchin mean in a casing may comprise filling a tube-shaped casing with the processed sea urchin meat and folding, tying off, or otherwise sealing the casing material to form a continuous enclosed casing around each pellet. In other embodiments, the step of wrapping the processed sea urchin meat in a casing may comprise wrapping a flat sheet of casing around the processed sea urchin meat and folding or tying off the ends of the casing, e.g., with at least one of a short length of fishing line, a staple, a clip, a thread, a short length of wire, and the like.

The step of engaging the sea urchin meat with a fishing device may comprise include inserting the pellets, having a predetermined size and shape, into one or more cavities having a complementary shape to that of the pellets (e.g., a cylindrical shape, a substantially spherical or hemispherical shape, a cubic shape, and the like) “in the body of a lure. The pellets may also be placed on a fishing hook or the hook of a lure. The pellets are preferably thawed when they are inserted into the lure or place on a hook to allow for dissolution in water and the diffusion of sea urchin meat particulates into the water.

The fishing device or lure may subsequently be immersed in a body of water. The sea urchin meat may then be operable to slowly dissolve into the water, allowing a remotely located fish to sense the sea urchin meat, and find the fishing device.

Further objects and aspects of the present invention will be apparent from the description provided herein.

### BRIEF DESCRIPTION OF THE DRAWINGS

FIG. 1A shows a flow chart for a sea urchin fish bait device, according to an embodiment of the present invention.

FIG. 2 shows a flow chart for a sea urchin fish bait device, according to an embodiment of the present invention.

FIG. 3A shows a side view of a sea urchin fish bait device, according to an embodiment of the present invention.

FIG. 3B shows a rear perspective view of a sea urchin fish bait device, according to an embodiment of the present invention.

FIG. 3C shows a side view of a sea urchin fish bait device, according to an embodiment of the present invention.

FIG. 4 shows a side view of a sea urchin fish bait device, according to an embodiment of the present invention.

FIG. 4B shows a side view of a sea urchin fish bait device, according to an embodiment of the present invention.

FIG. 5 shows a side view of a sea urchin fish bait device, according to an embodiment of the present invention.

chin fish bait device, according to an embodiment of the present invention.

FIG. 6A shows a side view of a sea urchin fish bait device, according to an embodiment of the present invention.

FIG. 6B shows a side view of a sea urchin fish bait device, according to an embodiment of the present invention.

### DETAILED DESCRIPTION OF THE DRAWINGS

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

Reference will be made to the exemplary illustrations in the accompanying drawings, and like reference characters may be used to designate like or corresponding parts throughout the several views of the drawings.

The present invention may provide a bait device 100 for efficiently and effectively using sea urchin meat 101 as fish bait. The bait device 100 may comprise sea urchin meat 101 wrapped in a casing 110 and formed into a pellet 120, and a fishing device 130 for securing said pellet 120 and catching a fish.

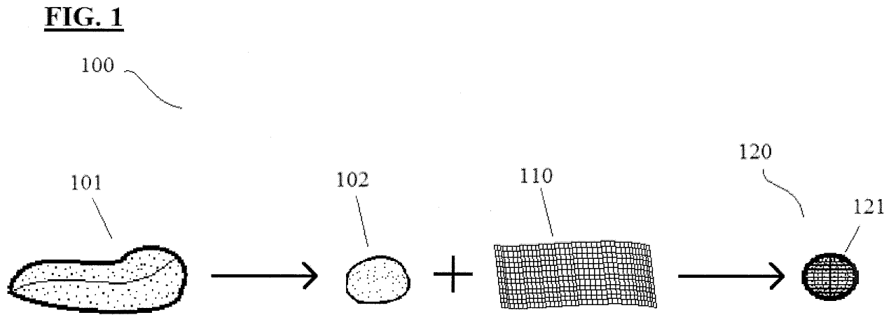

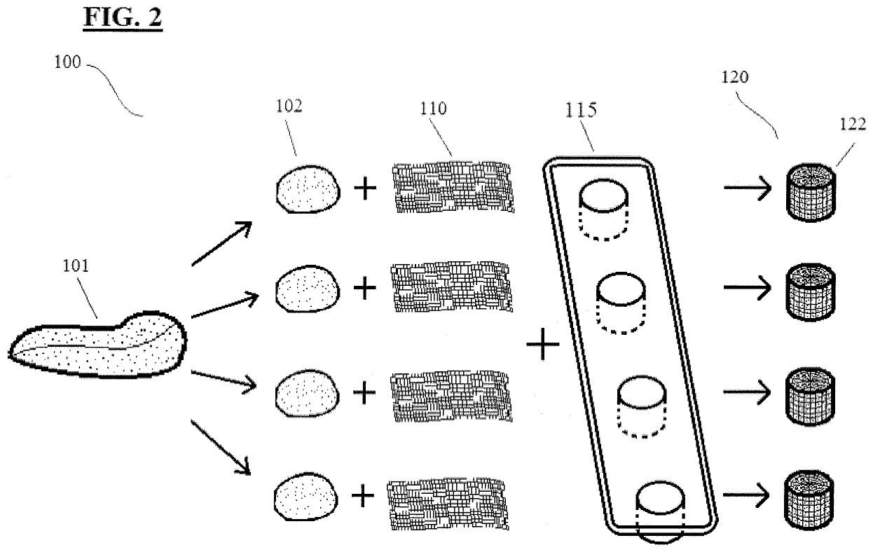

As seen in FIGS. 1 and 2 the sea urchin meat 101 may comprise at least one of a gonad and gametes of a sea urchin. The sea urchin meat 101 may comprise the tissue of any species of sea urchin, (e.g., a red sea urchin (Mesocentrotus franciscanus), a purple sea urchin (Strongylocentrotus purpuratus), etc.). The sea urchin meat 100 may be processed into a pellet 120, wherein the sea urchin meat 101 is mashed, ground, or blended into a mass 102 with uniform consistency, wrapped in a casing 110, and formed into a pellet 120 having a substantially spherical shape 121 (see FIG. 1), a substantially cylindrical shape 122 (see FIG. 2), or other appropriate configuration.

As seen in FIG. 2, the sea urchin meat 101 may be formed into a plurality of pellets 120. The plurality of pellets 120 may be formed by processing the sea urchin meat 101 into a plurality of masses 102 having a substantially uniform consistency a size, wrapping the plurality of masses 102 in a plurality of casings 110, and pressing the masses into a plurality of substantially cylindrical-shaped cavities in a tray 115 to form a plurality of substantially cylindrically shaped pellets 122.

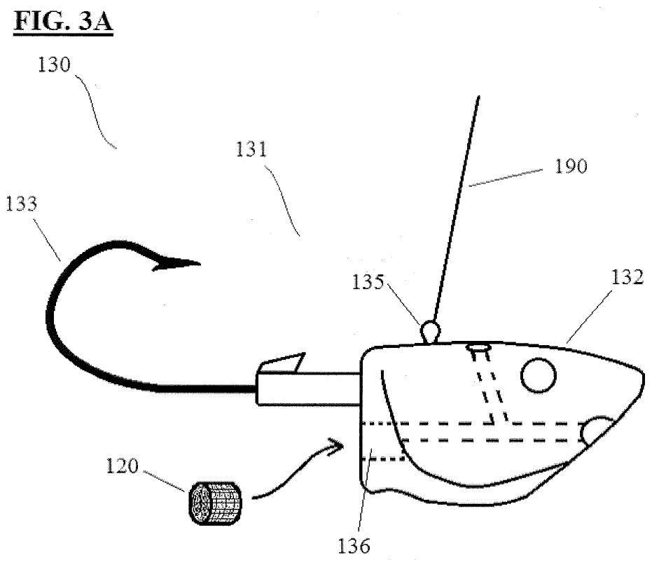

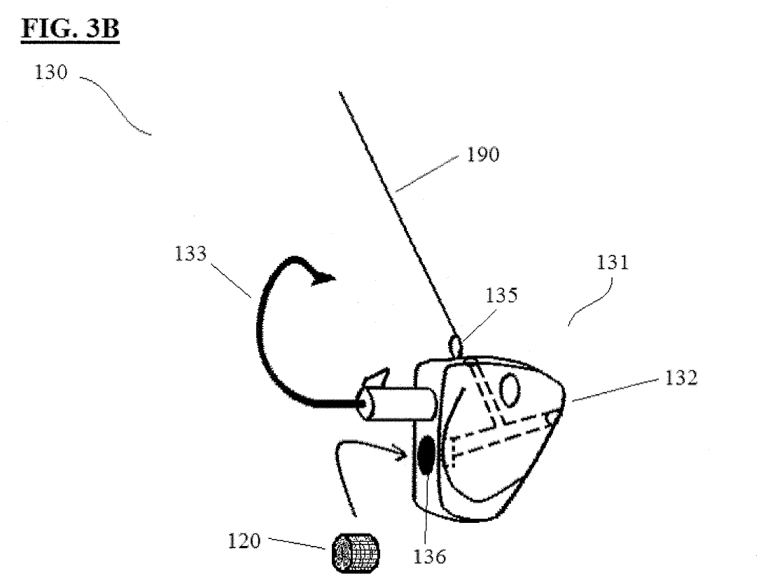

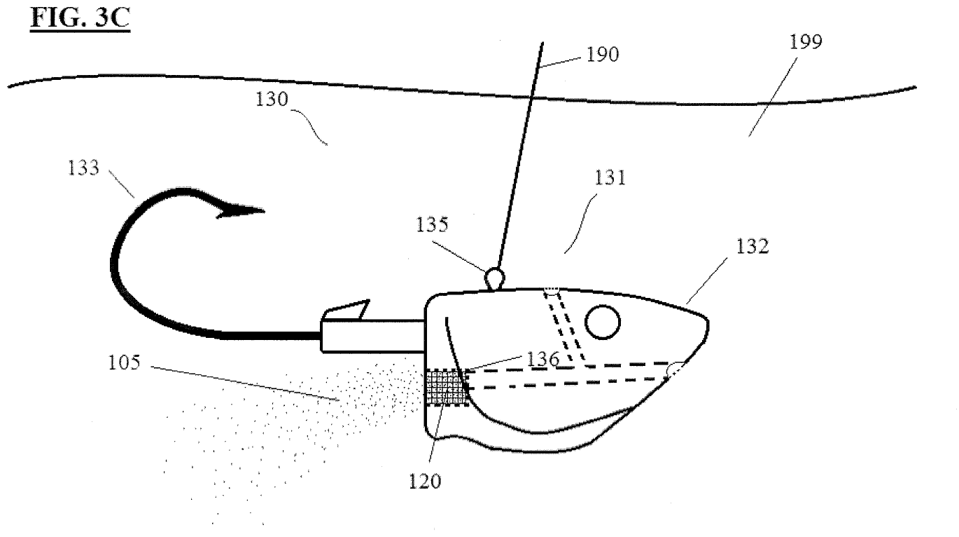

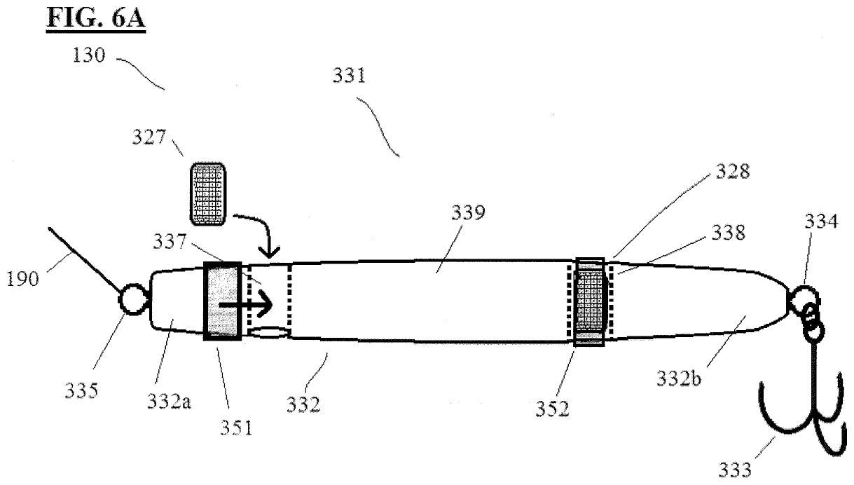

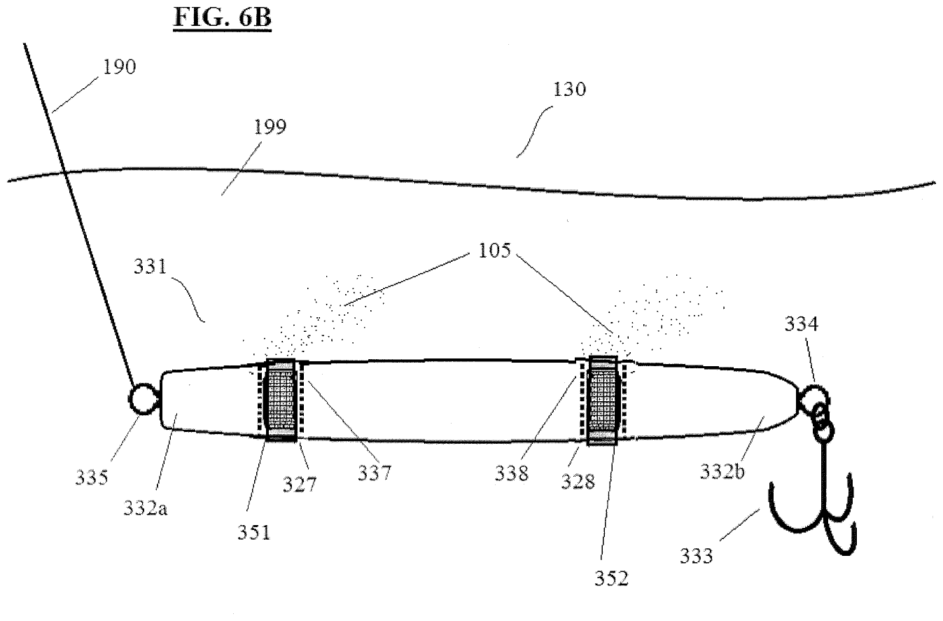

The casing 110 may comprise any material operable to incrementally release the sea urchin meat 101 (and any other components of the pellet 120) from the pellet 120 in a controlled manner (e.g., the pellet 120 dissolves, releasing small pieces of sea urchin meat into the water 199 slowly), such that target fish (not shown) are able to sense the pellet 120 engaged with the fishing device 130 quickly and for a substantial amount of time. The casing may comprise a material having a porosity which allows only small pieces 105 (see FIGS. 3C and 6B) of the sea urchin meat 101 (and any other components of the pellet 120) to release into the water 199, (e.g., a porosity in a range from about 0.5 mm to about 1.5 mm). The casing 110 may comprise a fiber-based mesh fabric.

As seen in FIGS. 3A through 6B, the fishing device 130 may comprise any device operable to be engaged with one or more pellets 120 and to catch a fish.

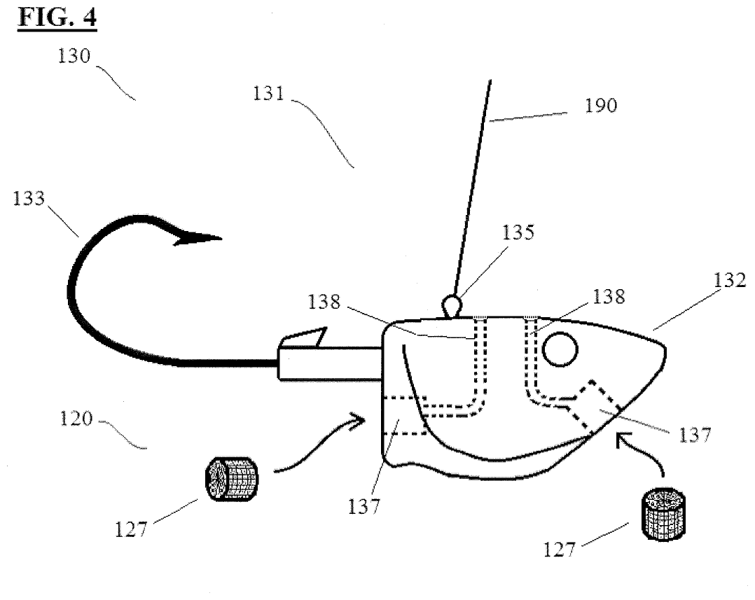

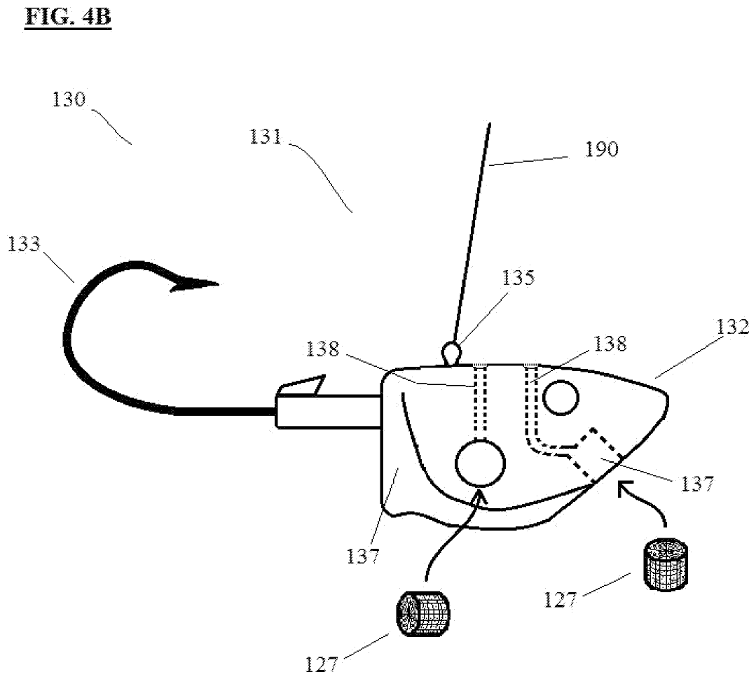

The lure 131 may comprise at least one cavity 136 in the body 132 for inserting and securing the pellet 120, the at least one cavity 136 having a shape and size complementary to the shape and size of the pellet 120 (e.g., a cylindrical shape comprising a diameter and depth). As seen in FIG. 4, the body 131 may comprise a plurality of cavities 136. The plurality of cavities may comprise at least a first cavity 137 having a first size and shape complementary to a size and shape of a first pellet 127, and a second cavity 138 having a second size and shape complementary to a size and shape of a second pellet 128. The cavity 136 or plurality of cavities 137, 138 may be located in any position(s) on the body 132 which is/are advantageous for attracting a fish. FIG. 4B shows a further embodiment in which at least one cavity 136 is located on a lateral side of the body 132.

The fishing device 130 may be tied to the line 190 of a fishing pole via a line securing loop 135, and may comprise at least one of a lure 131 (see FIG. 3A), and a simple hook 140 on a line. The lure 131 may comprise a body 132 and a hook 133, wherein the body 132 and the hook 133 may each comprise a broad range of shapes and sizes which are known in the fishing art to be effective at catching a fish. As seen in FIG. 3A-3C, the lure 131 may comprise a body 132 having a shape substantially similar to a fish head, and a single hook 133 extending from the back of the fish head shaped body 132.

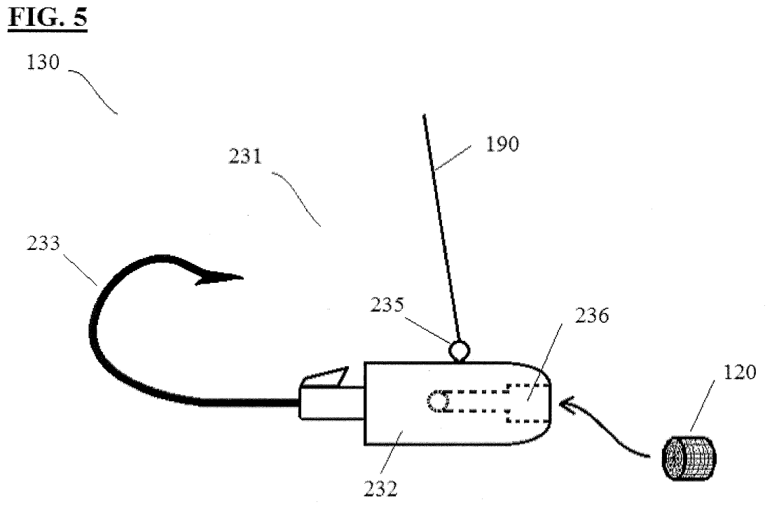

As seen in FIG. 5, in another embodiment the fishing device 130 may comprise a lure 231 having a cylindrical or slug-shaped body 232 and a cavity 236 comprising a substantially cylindrical shape located at a leading end of the body 232, the hook 233 being positioned on the opposite end of the body 232 from the 233.

In yet another embodiment, as seen in FIGS. 6A and 6B, the lure 331 may comprise a tapered cylindrical shape having a line securing loop 335 located at a first tapered end 332a and multi-point hook 333 swinging freely from the hook engagement loop 334 located at a second tapered end 332b. The cavity may comprise a plurality of cavities 337, 338 having substantially the same size and shape, and complementary to the size and shape of a plurality of pellets 327, 328, each having a substantially spherical shape. Each cavity 337, 338 may be located on a lateral surface 339 (e.g., the curved outer surface of the cylinder shape) of the body 332, allowing each of the first pellet 327 and second pellet 328 to release small pieces of sea urchin meat 105 into the water in order to attract a fish.

The present invention may further provide a method for efficiently and effectively using sea urchin meat 101 as fish bait. As seen in FIGS. 1 and 2, the method may comprise the steps of providing sea urchin meat 101, processing the sea urchin meat into a mass of substantially uniform consistency 102, forming the sea urchin meat into a pellet shape 120, wrapping the sea urchin meat in a casing 110, and engaging the sea urchin meat 101 with a fishing device 130 (see FIGS. 3C and 6B).

The step of forming the sea urchin meat 101 into a pellet shape 120 may comprise at least one of rolling the mass of sea urchin meat 102 by hand into a substantially spherical shape 121 (see FIG. 1), and forming the sea urchin meat 101 into a plurality of pellets 120 by pressing the processed mass of sea urchin meat 102 into a tray 115 having a plurality of pellet shaped cavities (e.g., a tray with a plurality of substantially cylindrical cavities, each cavity having an open upper end) to form cylindrical pellets 122 (see FIG. 2).

The step of engaging the sea urchin meat 101 with a fishing device 130 may comprise at least one of impaling a pellet 120 on a fishing hook or the hook 133 of a lure 131, and inserting a pellet 120 into a cavity 136 of a lure 131 (see FIGS. 3A-3C). The pellet 120 may be frozen or unfrozen at the time of engagement with the fishing device 130. The step of engaging the sea urchin meat 101 with a fishing device 130 may comprise inserting a plurality of pellets 127/327, 128/328 into a plurality of cavities 137/337, 138/338 of a lure 131/331 (see FIGS. 4 and 4B).

The method may further comprise the step of putting the fishing device 130 into a body of water 199, the step comprising tying a fishing line 190 to a securing member (e.g., a line securing loop 135/335) of the fishing device 130 and immersing the fishing device 130 in the body of water 199 (see FIGS. 3C and 6B). The pellet 120 may be operable to slowly dissolve, releasing small pieces of sea urchin meat 105 into the water 199, allowing a remotely located fish to sense the sea urchin meat 101, find the fishing device 130, and be caught by the fishing device 130 (e.g., be impaled by a lure's hook 133/333 or a fishing hook 140).

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed:

1. A bait device, comprising:
a. a casing operable to release said sea urchin meat in a controlled manner, said casing comprising a membrane or fabric; and
b. sea urchin meat encapsulated in said casing, forming a pellet.

2. The bait device of claim 1, wherein said pellet having a pre-determined shape

3. The bait device of claim 1, further comprising a fishing device.

4. The bait device of claim 3, wherein said fishing device comprises a lure having a body.

5. The bait device of claim 4, wherein said body comprises a cavity for securing said pellet, said cavity having a shape that is complementary to a pre-determined shape of said pellet.

6. The bait device of claim 5, wherein said pellet is inserted into said cavity.

7. The bait device of claim 1, wherein said casing comprises a fiber-based fabric.

8. The bait device of claim 6, wherein said casing comprises a porosity in a range of about 0.5 mm to about 1.5 mm.

9. The bait device of claim 5, wherein said cavity comprises a plurality of cavities.

10. The bait device of claim 3, wherein said fishing device comprises a hook, said pellet being impaled on said hook.

11. A method of using sea urchin meat as fish bait, the method comprising the steps of:
a. processing sea urchin meat for forming into a pellet;
b. forming said sea urchin meat into a pellet;
c. enveloping said sea urchin meat in a casing, said casing comprising a membrane or fabric; and
d. inserting said pellet into a cavity in a fishing device.

12. The method of claim 11, wherein said cavity comprises a shape complementary to a shape of a pre-determined shape of said pellet.

13. The method of claim 12, wherein said lure comprises a plurality of cavities therein, said plurality of cavities each having a shape complementary to said pre-determined shape of said pellet.

14. The method of claim 11, wherein forming said sea urchin meat into a pellet comprises the steps of:
a. mashing said sea urchin meat into a mass having a substantially uniform consistency; and
b. freezing said pellet.

15. The method of claim 14, wherein forming said sea urchin meat into a pellet further comprises the step of:
a. inserting said mass having substantially uniform consistency into a molding structure having a pre-determined shape that is complementary to said cavity in said fishing device.

16. A bait and device system, comprising:
a. a casing operable to release said sea urchin meat in a controlled manner, said casing comprising a membrane or fabric; and
b. sea urchin meat encapsulated in said casing, forming a pellet having a pre-determined shape;
c. a fishing device having a body comprising at least one cavity for securing said pellet, said cavity having a shape that is complementary to said pre-determined shape of said pellet.

17. The system of claim 16, wherein said pellet is inserted into said cavity.

18. The system of claim 16, wherein said casing comprises a fiber-based fabric.

19. The bait device of claim 18, wherein said casing comprises a porosity in a range of about 0.5 mm to about 1.5 mm.

20. The bait device of claim 16, wherein said cavity comprises a plurality of cavities, each having a shape that is complementary to said pre-determined shape of said pellet.
